(19) United States
(12) Patent Application Publication
(10) Pub. No.: US 2022/0133090 A1
(43) Pub. Date: May 5, 2022

(54) Grill stove stand

(71) Applicant: Nelson Shen, ONGGUAN (CN)

(72) Inventor: Nelson Shen, ONGGUAN (CN)

(21) Appl. No.: 17/088,528

(22) Filed: Nov. 3, 2020

(51) Int. Cl. A47J 37/07; F24C 15/08; F24C 15/10

(52) U.S. Cl. CPC A47J 37/0786; A47J 37/0704; F24C 15/10; F24C 15/08

(57) ABSTRACT

A grill stove stand contains: a body and a heating device. The body includes a grill base, multiple support feet, a communication space defined among a bottom of the grill base and the multiple support feet, a grilling platform mounted on a top of the grill base and configured to grill ingredients, and a combustion chamber defined in the grill base. The heating device includes multiple heating tubes accommodated in the combustion chamber, and the heating device includes at least one switch arranged on the grill base and connected with the multiple heating tubes so as to control a grilling temperature of the multiple heating tubes. Preferably, a movable isolation assembly is fixed on a bottom of the grill base and is opened or closed.

### FIELD OF THE INVENTION

The present invention relates to a grill stove stand which is capable of grilling different ingredients in various grilling temperatures based on using requirements.

### BACKGROUND OF THE INVENTION

A conventional gas grill stove contains multiple gas tubes accommodated therein. However, no any isolation spaced is defined to enhance a grilling temperature.

The present invention has arisen to mitigate and/or obviate the afore-described disadvantages.

### SUMMARY OF THE INVENTION

The primary aspect of the present invention is to provide a grill stove stand which is capable of grilling different ingredients in various grilling temperatures based on using requirements.

To obtain the above mentioned aspect, a grill stove stand provided by the present invention contains: a body and a heating device.

The body includes a grill base, multiple support feet, a communication space defined among a bottom of the grill base and the multiple support feet, a grilling platform mounted on a top of the grill base and configured to grill ingredients, and a combustion chamber defined in the grill base.

The heating device includes multiple heating tubes accommodated in the combustion chamber, and the heating device includes at least one switch arranged on the grill base and connected with the multiple heating tubes so as to control a grilling temperature of the multiple heating tubes. Preferably, a movable isolation assembly is fixed on a bottom of the grill base and is opened or closed.

Preferably, the movable isolation assembly includes a first movable partition and a second movable partition which are moved to stack or expand.

Preferably, each of the first movable partition and the second movable partition has multiple spaced air orifices corresponding to a respective heating tube.

Preferably, the first movable partition has a pull hook disposed on a bottom thereof and configured to move the first movable partition.

### BRIEF DESCRIPTION OF THE DRAWINGS

FIG. 1 is a perspective view showing the exploded components of a grill stove stand according to a preferred embodiment of the present invention.

FIG. 2 is a perspective view showing the assembly of the grill stove stand according to the preferred embodiment of the present invention.

FIG. 3 is a perspective view showing the operation of the grill stove stand according to the preferred embodiment of the present invention.

FIG. 4 is another perspective view showing the operation of the grill stove stand according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

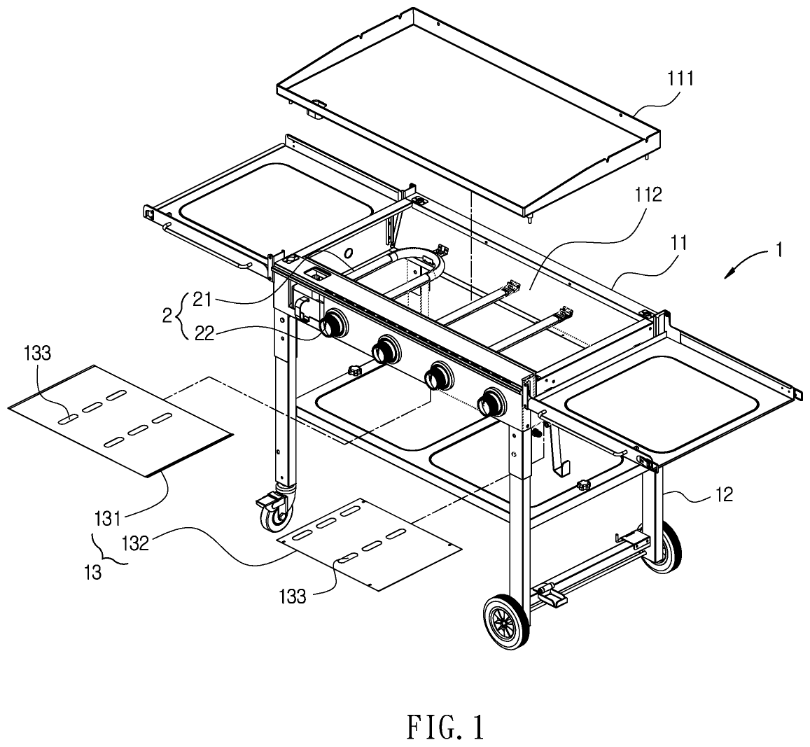

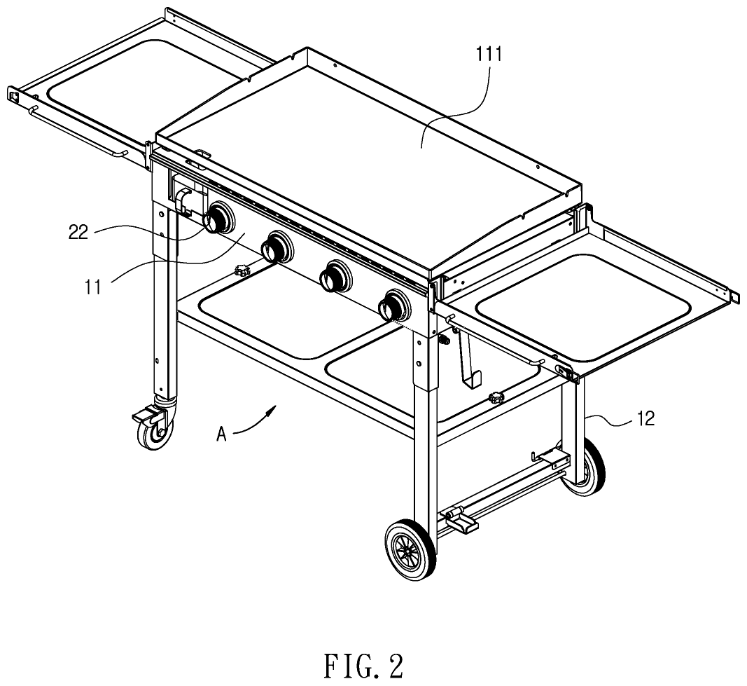

With reference to FIGS. 1-4, a grill stove stand according to a preferred embodiment of the present invention is capable of grilling different ingredients in various grilling temperatures based on using requirements.

The grill stove stand comprises: a body 1 and a heating device 2.

The body 1 includes a grill base 11, multiple support feet 12, a communication space A defined among a bottom of the grill base 11 and the multiple support feet 12, a grilling platform 111 mounted on a top of the grill base 11 and configured to grill ingredients, and a combustion chamber 112 defined in the grill base 11.

The heating device 2 includes multiple heating tubes 21 accommodated in the combustion chamber 112, and the heating device 2 includes at least one switch 22 arranged on the grill base 11 and connected with the multiple heating tubes 21 so as to control a grilling temperature of the multiple heating tubes 21, wherein a movable isolation assembly 13 is fixed on a bottom of the grill base 11 and is opened or closed.

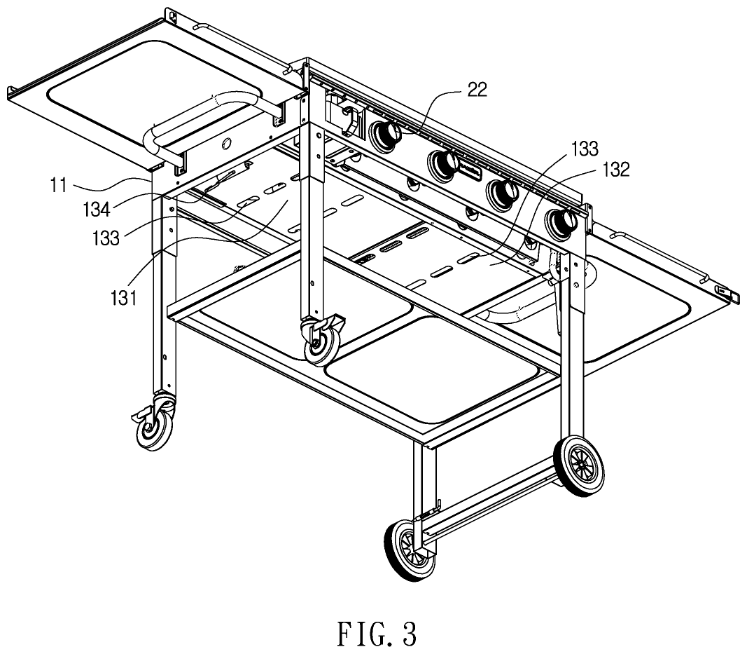

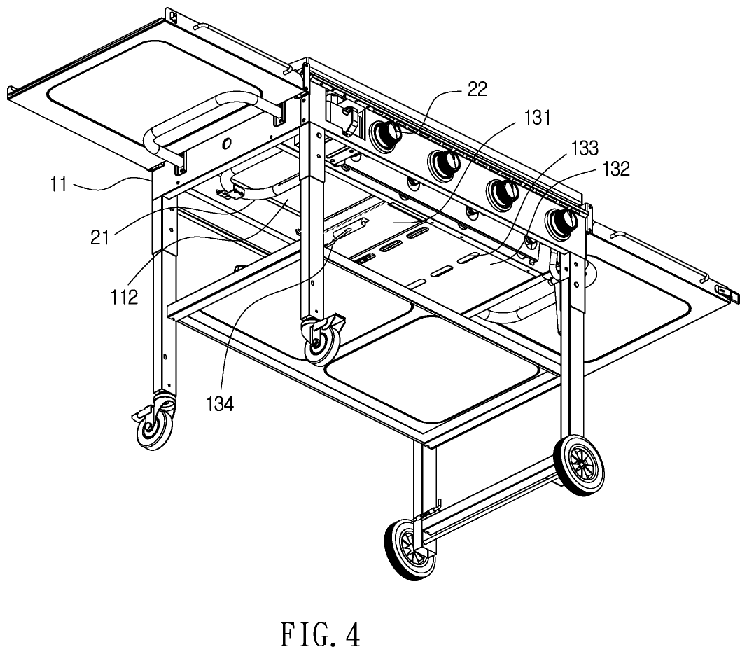

When the movable isolation assembly 13 is closed, the combustion chamber 112 and the communication space A are communicated or isolated in a large area so that a grilling temperature of the grilling platform 111 is influenced directly by the multiple heating tubes 21 and by opening or closing the combustion chamber 112. When the combustion chamber 112 is closed, a heat of the grill stove stand and the grilling temperature of the grilling platform 111 increase so as to grill the ingredients in a high grilling temperature as shown in FIG. 3. When the combustion chamber 112 is opened, the heat of the grill stove stand is dissipated quickly so as to grill the ingredients in a low grilling temperature. Preferably, the grill stove stand is stored after being turned off to cool its heat quickly, as illustrated in FIG. 4.

The movable isolation assembly 13 includes a first movable partition 131 and a second movable partition 132 which are moved to stack or expand. When the first movable partition 131 and the second movable partition 132 are stacked, the combustion chamber 112 is communicated with the communication space A. When the first movable partition 131 and the second movable partition 132 are moved to expand, the combustion chamber 112 is isolated from the communication space A.

Each of the first movable partition 131 and the second movable partition 132 has multiple spaced air orifices 133 corresponding to a respective heating tube 21, such that airs flow into the combustion chamber 112 via the multiple spaced air orifices 133, thus producing oxygen evenly to enhance the grilling temperature of the respective heating tube 21.

The first movable partition 131 has a pull hook 134 disposed on a bottom thereof and configured to move the first movable partition 131, thus avoiding a scald by the first movable partition 131.

Accordingly, the combustion chamber and the communication space are communicated or isolated in the large area so that a grilling temperature of the grilling platform is influenced directly by the multiple heating tubes and by opening or closing the combustion chamber, thus grilling the different ingredients in the various grilling temperatures based on using requirements

While various embodiments in accordance with the present invention have been shown and described, it is clear to those skilled in the art that further embodiments may be made without departing from the scope of the present invention.

What is claimed is:

1. A grill stove stand comprising:
a body including a grill base, multiple support feet, a communication space defined among a bottom of the grill base and the multiple support feet, a grilling platform mounted on a top of the grill base and configured to grill ingredients, and a combustion chamber defined in the grill base;
a heating device including multiple heating tubes accommodated in the combustion chamber, and the heating device including at least one switch arranged on the grill base and connected with the multiple heating tubes so as to control a grilling temperature of the multiple heating tubes, wherein a movable isolation assembly is fixed on a bottom of the grill base and is opened or closed.

2. The grill stove stand as claimed in claim 1, wherein the movable isolation assembly includes a first movable partition and a second movable partition which are moved to stack or expand.

3. The grill stove stand as claimed in claim 2, wherein each of the first movable partition and the second movable partition has multiple spaced air orifices corresponding to a respective heating tube.

4. The grill stove stand as claimed in claim 2, wherein the first movable partition has a pull hook disposed on a bottom thereof and configured to move the first movable partition.
